(19) United States
(12) Patent Application Publication
(10) Pub. No.: US 2025/0376996 A1
(43) Pub. Date: Dec. 11, 2025

(54) MAGNETIC ACTUATING DEVICE

(71) Applicant: Nakanishi Jaeger GmbH, Ober-Mörlen (DE)

(72) Inventors: Axel FISCHER, Ober-Mörlen (DE); Frank WOLFF, Herborn (DE)

(73) Assignee: Nakanishi Jaeger GmbH, Ober-Mörlen (DE)

(21) Appl. No.: 18/874,219

(22) PCT Filed: Jun. 13, 2023
(86) PCT No.: PCT/DE2023/100447

§ 371 Date: Dec. 12, 2024

(30) Foreign Application Priority Data
Jun. 13, 2022 (DE) 10 2022 114 839.4
Jul. 25, 2022 (DE) 10 2022 118 526.5

(51) Int. Cl. F15B 15/20; F15B 15/14; H01F 7/08; H01F 7/16

(52) U.S. Cl. CPC F15B 15/20; F15B 15/14; H01F 7/081; H01F 7/16; F15B 2015/206

(57) ABSTRACT

A magnetic actuating device includes a housing and a piston rod movable along a longitudinal axis of the housing between two end positions, which includes at least one piston extending radially from the piston rod and containing a ferromagnetic material or at least partially surrounds the latter. Furthermore, at least one magnet system is fixed to the housing, wherein the piston and magnet system form at least one fluid gap system with axially variable fluid gaps, into each of which at least one fluid supply for the addition of actuating fluid opens, so that the piston rod can be moved into its end positions at least by the addition of actuating fluid between the piston and magnet system.

The invention relates to a magnetic actuating device with a piston rod located in a housing and a piston attached to it, which can be moved to its end position by an actuating fluid and the support of a magnet system and held there.

DE 197 12 293 A1 discloses an electromagnetically operating actuator having two magnet systems that are distanced from each other and each have an exciter coil, between which an armature disk that is firmly connected to a shaft is arranged. The armature disk is located between two springs that act in opposite directions and can be moved by the magnet systems into two switch positions. One of the magnet systems is assigned a permanent magnet polarized in the direction of armature movement, which stabilizes the armature in a switch position when no current is applied. If the armature is to be held in the other switch position, then a permanent current is required.

Furthermore, an electromagnetic linear motor is known from EP 0 568 028 A1, consisting of an armature, two inner pole shoes, two outer pole shoes, two permanent magnets and a coil, wherein the armature, together with the inner pole shoes and the outer pole shoes, forms an air gap system comprising four magnetic air gaps that can be varied in the axial direction and are of equal size in the center position. The permanent magnets stabilize the armature in the center position when the coil is currentless. The pole shoes have the form of half-shells and, together with the half-shell permanent magnets, form two magnet systems with fixed poles.

An electromagnetic lifting magnet for achieving high holding forces in the stable end positions is known from DE 102 07 828 B4. It consists of a stator with two axially distanced magnet systems, each of which has an exciter coil for generating an electromagnetic flux. An armature is guided between the two magnet systems, which carries a permanent magnet assembly polarized perpendicular to its direction of movement for permanent holding of the armature without a current flow in the energizing coil. The permanent magnet assembly is situated here between the two energizing coils, whereby its effectiveness is reduced due to stray flux. Furthermore, the usually brittle material of the permanent magnet assembly can suffer from an impact-like movement of the armature.

DE 10 2013 102 400 A1 describes an electromagnetic actuating device with a housing, an armature that can be moved between two end positions in the housing, which has two armature discs arranged at a distance from each other and an armature shaft. Two ring-shaped arrangements of permanent magnets polarised in the same direction radially to the axis are arranged between the armature discs, non-detachable from the housing, and form two magnet systems and one air gap system with axially adjustable air gaps. A ring-shaped coil that can be connected to a power source is arranged between the two permanent magnets. The magnet systems and the air gap system are laid out so that the armature can be held in each of the two end positions without exciting the coil and can be moved from one end position to the opposite end position by exciting the coil.

A bistable sensor and actuating device is known from DE 10 2016 105 000 A1, which comprises an armature unit arranged in a housing and consisting of a disc-shaped permanent magnet body and a striker unit attached to it. The armature unit can be moved axially into its stable end positions in the housing by pneumatic drive means.

Well-known actuating devices are often used to operate tool clamping fixtures in motor spindles that are driven hydraulically or pneumatically.

The invention is based on the task of providing an actuating device that has sufficient holding force to keep the actuating device stable in its end positions and that can be activated quickly.

The problem is solved by the features of claim 1. Preferred embodiments are described in the dependent claims.

The problem is solved in accordance with the invention in that a magnetic actuating device with a housing, a piston rod which can be moved along a longitudinal axis of the housing between two end positions and has at least one piston which extends radially from the piston rod and consists of a ferromagnetic material or at least partially surrounds it, with at least one magnetic system which is fixed to the housing, wherein the piston and magnetic system, or in particular the housing, form at least one fluid gap system with axially variable fluid gaps, into which at least one fluid supply for the addition of actuating fluid opens in each case, so that the piston rod can be actuated at least by the addition of actuating fluid. in particular housing form at least one fluid gap system with axially variable fluid gaps, into each of which at least one fluid supply for the addition of actuating fluid leads, so that the piston rod can be moved into its end positions at least by the contribution of actuating fluid between piston and magnet system, or in particular housing.

It can be advantageous if the piston rod has two pistons that are arranged at a distance from each other and extend radially from the piston rod and are made of a ferromagnetic material or at least surround it in some areas. In this embodiment, the magnetic system, which is fixed to the housing, is arranged in particular between the pistons.

However, it is also possible for the actuating device to comprise two magnet systems that are fixed to the housing, between which only one piston can be moved and which each define an end position of the piston. The magnet system or magnet systems can form part of the housing or be integrated in a housing part. Furthermore, magnet carriers can be provided which hold the magnet system. The magnet system or the magnet systems, alone or in combination with further housing parts or magnet carriers, form in particular at least one surface of the fluid gap system, which is opposite at least one surface of the piston, which also forms at least one surface of the fluid gap system. For the purposes of the invention, the end positions of the piston rod correspond to the end positions of the piston or pistons.

In particular, the invention relates to a magnetic actuating device with a housing, a piston rod which can be moved along a longitudinal axis of the housing between two end positions and which comprises two pistons which are arranged at a distance from one another and extend radially from the piston rod and consist of a ferromagnetic material, with at least one magnet system which is fixed to the housing and is located between the pistons, wherein the piston and magnet system form a fluid gap system with axially variable fluid gaps, into each of which leads at least one fluid supply for the contribution of actuating fluid, so that the piston rod can be moved into its end positions at least by the contribution of actuating fluid between the piston and magnet system and can be held there by the magnet system.

In a preferred embodiment, the invention refers to a magnetopneumatic actuating device, comprising a housing, a piston rod movable along a longitudinal axis of the housing between two end positions, which comprises two pistons arranged at a distance from each other and extending radially from the piston rod and consisting of a ferromagnetic material, with at least one magnet system between the pistons fixed to the housing and, wherein the pistons and magnet system form a fluid gap system, in particular an air gap system with axially variable fluid gaps, in particular air gaps, into each of which at least one fluid supply, in particular air supply for the contribution of actuating fluid, in particular actuating air, opens, in particular air gap system with axially variable fluid gaps, in particular air gaps, into each of which at least one fluid supply leads, in particular air supply for the contribution of actuating fluid, in particular actuating air, so that the piston rod can be moved into its end positions at least by the contribution of actuating fluid, in particular actuating air, between the pistons and the magnet system and can be held there by the magnet system. The use of compressed air as an actuating fluid has the particular advantage that existing resources can be used and thus already present compressed air connections can be utilized.

The actuating device according to the invention combines magnetic forces with the forces exerted on the pistons by the actuating fluid, whereby an increase in the piston force can be achieved and the pistons are held stable in their end positions by the magnetic system. To move the pistons, a fluid is filled into one of the fluid gaps, preferably at high pressure, so that a piston moves from its end position to the opposite end position. As the piston is moved in the direction of the magnetic system, a magnetic attraction force is also effective on the piston from a certain distance from the magnetic system, so that the movement of the piston generated by the fluid is supported by the magnetic attraction force. The piston is then held stable in its end position by the magnetic system. As the piston rod can be moved in two opposite directions by the forces exerted on both pistons, the actuating device is effective in two directions.

The invention has the advantage over the prior art that the pistons can be stably held in both end positions. By adding fluid, preferably into both fluid gaps, rapid movement of the pistons can be achieved. The actuating device can make use of already present resources, which contributes to low costs and a small construction size. Furthermore, the magnet system with the magnetic components is securely embedded in the housing and thus protected against dynamic forces.

In one embodiment, the magnetic system comprises a ring-shaped arrangement of one permanent magnet or several permanent magnets polarized radially in the same direction. Magnets made of sensitive magnetic materials, for example composite materials, can be used, which enable high polarization values and field strengths. The permanent magnets can advantageously consist of individual magnets arranged in a ring or be made in the form of a ring magnet. In a preferred embodiment of the invention, the magnet system is designed with rotational symmetry. However, forms deviating from this are also possible. Shapes such as ring-shaped, angular or the like are also possible. The magnet system can also be formed as an interrupted ring, i.e. not rotationally symmetrical.

The magnet system can comprise a configuration of radially inner and/or radially outer pole pieces made of a magnetic flux conducting material. The pole pieces can surround the permanent magnets and thus protect them from dynamic use. The inner and outer pole pieces can consist of a configuration of soft magnetic material and can be in the form of closed rings.

In one embodiment, it is provided that the magnet system comprises a coil, in particular a ring-shaped coil, which is associated with the magnet system and can be connected to a power source. A magnetic repulsion or attraction of the pistons can be achieved by a corresponding form of the coil. It can be advantageous if the coil is used in combination with permanent magnets or alone in the magnet system.

It may be provided that the coil is designed in the shape of a ring and is flanked on both sides by permanent magnets. The magnet system comprising permanent magnets and coil can be designed in such a way that the pistons can be fixed in the end position at or near the magnet system without exciting the coil and can be moved from one end position to the opposite end position by exciting the coil. This movement triggered by the excitation of the coil is additionally amplified by the pressure exerted on the piston surface by the fluid added, so that the forces acting on the piston increase and the displacement of the piston rod takes place at a high speed.

Depending on how the actuating device is used, the piston rod can be designed as a hollow body and can accommodate an actuating device that extends through the piston rod along the longitudinal axis. The axial movement of the piston rod can be used, for example, to couple or decouple the actuating device with another structural component. Nevertheless, the piston rod itself can also be designed as an actuating device and can be brought into active contact with a structural component.

The fluid that can to be introduced into the fluid gaps can be a gas or a liquid. These can be various types of fluids, such as, for example, but not limited to, air or oil. In order to add the fluid into the respective fluid gap, at least one fluid supply is provided in each fluid gap. This can be used both for the inlet of the fluid and the outlet of the added fluid, so that the fluid supply is also designed as a fluid outlet. To increase the clock frequency, it may be advantageous to have at least one fluid outlet in each of the fluid gaps in addition to the fluid supply. This allows the fluid to be discharged more quickly, so that the frequency of the actuating device can be increased.

It may be advantageous for a spring to act directly or indirectly on the piston rod. Depending on the arrangement of the spring, the piston rod can either move into one of its end positions against the spring force of the spring or the spring, or its spring force, can support the movement of the piston rod in one of its directions of movement. The spring can, for example, be supported in the piston rod on a shoulder of the piston rod on the one hand and on a shoulder of the housing on the other. Depending on the design of the spring, it can support the piston rod in one direction or the other. The spring can be designed as a tension or compression spring. It is understood that the use of several springs can also be considered.

To ensure a uniform and directed movement of the pistons, at least one guide means can be provided in one embodiment to guide at least one piston axially along the longitudinal axis. Such guide means can preferably be guide pins which are fixed in the housing, for example, and engage in bores in the piston.

In one embodiment of the invention, a cascade arrangement of several pistons with several magnet systems and several fluid gaps can be provided, wherein a piston can move back and forth between two magnet systems. This can increase the resulting force. Depending on the application, any number of fluid gap systems with magnet systems and pistons can be connected in series.

Depending on the use and therefore the design of the actuating device, it may be advantageous for the housing to have a multi-part design. This can simplify the performance of maintenance and any replacement of component parts. According to one proposal of the invention, the housing is made of non-magnetic material in order to avoid scattering of the magnetic flux and to keep the flux concentrated on the pistons. It may also be envisaged to use a ferromagnetic material to control the scattering.

The actuating device can be used for various purposes, such as, but not limited to, with a motorized spindle, clamping of work pieces or fast switching of electrical contacts.

A particularly advantageous use of the actuating device according to the invention comprises a motor spindle which contains in a spindle housing an electric motor and a spindle which can be driven in rotation by the latter and has a tool holder for a tool for machining work pieces, wherein the spindle is designed as a hollow shaft and comprises in its longitudinal bore a clamping device for clamping a tool or a tool holder, wherein the housing of the actuating device is attached directly or indirectly to the spindle housing, and wherein the piston rod can be brought into operative connection with an element of the clamping device which is axially displaceable in a longitudinal bore of the spindle, transmitting a force and a movement, and can move the clamping device into a release position. The present disclosure thus also includes the combination of a disclosed actuating device with a motorized spindle. The described advantages of the actuating device are to be applied analogously to the use or combination.

With the aid of the actuating device according to the invention, sufficiently high actuating forces can be achieved with a suitable size and acceptable weight in order to compress the spring clamping sets of such tool clamping devices and release the clamping device. With the device according to the invention, the holding forces required to hold the tool clamping device in the release position can also be generated with the aid of the magnet system.

The actuating device according to the invention can use resources of the motor spindle, such as pneumatic means, for operation. This is particularly advantageous if the fluid used is compressed air, which is already used for another purpose in the motor spindle. This compressed air can also be used as the actuating fluid in the actuating device according to the invention.

The actuating device can advantageously be attached directly to the motor spindle. For this purpose, the actuating device may comprise, in particular, means, such as bores or screw connections, which enable a quick and reversible connection to a motor spindle. However, the invention also includes embodiments in which the actuating movement and actuating force are transmitted to the motor spindle by interaction of the actuating device with a mechanical transmission system, e.g. push-pull cable, or by a hydraulic or pneumatic transmission system, whereby the weight of the motor spindle can be kept small.

In one embodiment, the piston rod of the magnetic actuating device can comprise a rotary feedthrough for passing one or more fluid channels. The channels can be used to ensure the supply of other components through the actuating device. The fluid channels can be designed to pass oil or compressed air, for example, but not exclusively.

Furthermore, it may be provided that at least one magnet system is present in the housing wall, so that a piston movable between its end positions interacts with at least one magnet system in at least one of its two end positions. It may also be provided that a magnet system is present in each of the two housing walls facing the moving piston, so that the moving piston is held by a magnet system in both of its end positions. This means that, in the embodiment, the piston can be moved into one of its two end positions at least by an actuating fluid added to the fluid gaps and held there at least by a magnet system. The piston can advantageously consist of a ferromagnetic material at least partially for this purpose. The magnet systems are preferably designed so that the pressure that is effective on the piston due to the added actuating fluid overcomes the holding forces of the magnet system and the piston can move to the opposite end position.

The invention is explained in more detail below with reference to an embodiment of the invention, which is shown in the drawing. It shows

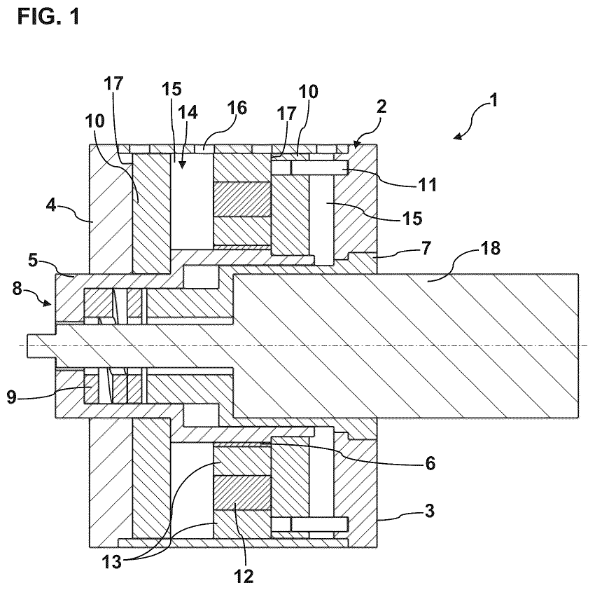

FIG. 1 a first embodiment of an actuating device with two pistons and

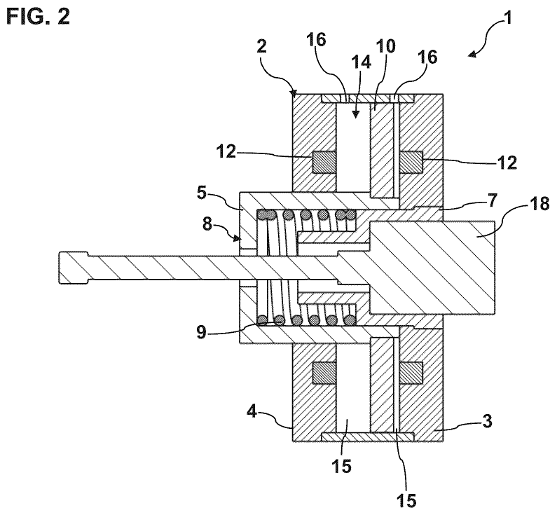

FIG. 2 an embodiment of the actuating device with a piston.

FIG. 1 shows an embodiment of a magnetic actuating device 1 with a housing 2, with a substantially cylindrical bore extending along its longitudinal axis, which projects at one end through a housing base 3 and at the other end through a lid 4 attached to the housing 1. The housing 2 contains a piston rod 5, which is movably mounted in the direction of the axis and formed as a hollow body.

In the embodiment shown, the housing 2 is designed in several parts. However, it may also be advantageous to construct the housing 2 essentially in one piece. Housing cover 4 and housing base 3 can be connected to a housing wall by means of screw connections not shown.

The piston rod 5 is mounted for axial movement along the longitudinal axis, e.g. via a plain bearing bush 6. The piston rod 5 is supported radially on the housing cover 4 and a guide piece 7 arranged in the housing 2. As indicated in FIG. 1, the stroke of the piston rod 5 can be defined by the design of the guide piece 7. However, this can also be achieved by other means known to the skilled person.

The guide piece 7 also serves to guide an actuator 8, which extends along the longitudinal axis through the guide piece 7 and the piston rod 5. A spring 9, e.g. a compression spring, can be provided in the piston rod 5, which can, for example, be supported with a first end on the piston rod 5 and with its second end on the guide piece 7.

The piston rod 5 comprises two pistons 10, which are arranged at a distance from each other, extend radially from the piston rod 5 and are made in particular of a ferromagnetic material. The pistons 10 have parallel side surfaces and cylindrical circumferential surfaces, with which they are mounted, for example, in sliding bushes not shown, which may be arranged in the bore of the housing 2. The pistons 10 may comprise different thicknesses. The connection between piston 10 and piston rod 5 can be designed to be reversible or irreversible. In order to simplify maintenance and disassembly of the pistons 10, the pistons 10 can be connected to the piston rod 5 by means of plug-in or screw connections, for example. The pistons 10 are axially movable with the piston rod 5 along the longitudinal axis, wherein guide means 11, such as guide pins, fixed in the housing 2 and engaging in the pistons 10 can be provided. This ensures uniform movement of the pistons 10.

A magnet system 12 is arranged between the pistons 10, which can be fixed to the housing wall, for example. The magnet system 12 can consist of a permanent magnet or several permanent magnets that are polarized radially in the same direction and thus transverse to the direction of movement of the piston rod 5. The permanent magnet can be designed as a ring magnet, for example, or as an arrangement of individual magnets polarized in the same direction. The permanent magnet can be held by magnet carriers 13 designed as pole pieces. The magnet carrier 13 can consist of an inner magnet carrier and an outer magnet carrier, between which the magnet system 11 designed as a permanent magnet is arranged, wherein the outer magnet carrier is firmly fixed to the housing 2 and the inner magnet carrier is stably supported on the plain bearing bush 6. Other designs of the permanent magnets, such as angular permanent magnets, are also possible. The pistons 10 and the magnet carriers 13 can be made of a material that conducts the magnetic flux well, in particular a soft magnetic material. The piston rod 5 can also be made of a material that conducts magnetic flux, but it is preferably made of non-magnetic material in order to counteract scattering of the flux. The housing 2 is also made of non-magnetic material.

Instead of the permanent magnet as the magnet system 12 or in addition to it, at least one coil that can be connected to a power source and comprises at least one winding can be provided (not shown). The coil can, for example, be located between two individual magnets arranged flanking each other and polarized in the same direction. Furthermore, for example, two or more magnet systems 12 can be arranged diametrically to the piston rod 5, in particular to the longitudinal axis, and comprise different compositions, i.e. different combinations of permanent magnets and/or coil are possible.

A fluid gap system 14 with axially variable fluid gaps 15 is provided between a piston 10 and the magnet system 12. At least one fluid supply 16 for the addition of actuating fluid leads to the fluid gaps 15. In one embodiment, the fluid supply 16 can also be designed as an outlet, so that actuating fluid is supplied or removed in a controlled manner via a valve, for example. However, in addition to a fluid supply 16, a separate fluid outlet can also be provided for each fluid gap 15. In the example shown, each fluid gap 15 comprises two fluid supply lines 16, which act as supply and outlet.

To actuate the actuating device 1, the actuating fluid is added to a fluid gap 15 via the fluid supply 16, so that a force is exerted on the piston surface and the piston 10 moves. Close to the magnetic system 12, an attractive force of the magnetic system 12 is also effective on the piston 10 moving in the direction of the magnetic system 12. After adding a defined amount of fluid, for example, the movement of the piston 10 stops and the piston 10 comes to a standstill at the magnetic system 12, where it is held stably in its end position by the magnetic force. By connecting the piston 10 to the piston rod 5, the piston rod 5 has also moved to its corresponding end position and, for example, exerted a force on another object through its kinetic energy in the function of an actuator 8.

In the actuating device 1, the pistons 10 can be held in their two end positions on the magnet system 12 with comparatively high force by the magnetic force of the magnet system 12. The middle position of the pistons 10 with equally large fluid gaps 15 is unstable.

In order to move the piston 10 held on the magnet system 12 to its opposite end position, the actuating fluid is drained from the previously filled fluid gap 15 and actuating fluid is added to a gap 17 between the magnet system 12 and the piston 10. The forces acting on the piston 10, which is held on the magnet system 12 by magnetic force, cause the piston 10 to move against the magnetic force to its opposite end position. The movements of the piston 10 can be supported by the addition of actuating fluid in the corresponding gap 17 near the second piston 10. This means that both fluid gaps 15 can preferably be filled or emptied with actuating fluid at the same time, so that preferably forces emanating from the actuating fluid always act on both pistons 10. This increases the forces acting on the pistons 10 and the piston rod 5.

It can be advantageous if the piston rod 5 comprises a rotary feedthrough 18 for passing through one or more fluid channels in order to supply structural components with necessary fluids through the actuating device 1.

The actuating device 1 can be used, for example, when changing a tool on a motor spindle, which is not shown. The actuating device 1 can be attached to a spindle housing by means of a cover. The end of the shaft protruding from the cover can, in the design of the plunger, engage in a longitudinal bore in a spindle and, in the position of the piston rod 5 retracted into the housing, face an end face of an element of a clamping device, in particular a plunger of the clamping device, at a small distance. In this described position of the actuating device 1, the tool holder can be clamped by the clamping device, for example with the help of the force of disk springs.

If the tool holder is to be changed with a tool attached to it, actuating fluid is added to a fluid gap 15 after the spindle is stopped and the piston rod 5 is moved in the opposite direction, in which a piston 10 is stably held by the magnet system 12. The piston rod 5 moves into the position further out of the housing 2. Here, the shaft with the plunger is moved against the force of the disk springs in the direction of the clamping system to such an extent that, for example, the tool holder can be released from the clamping device and the tool taper can be released. The tool holder and the tool attached to it can be removed manually or automatically in this way. The tool cone can be attached either directly to a machining tool or to the tool holder.

After inserting the new tool into the receptacle of the spindle, the actuating fluid is removed from the one fluid gap 15 and added to the gap 17 between the magnet system 12 and piston 10 or to the gap 17 between the housing wall and piston 10 in order to clamp a new tool. The spring 9 can support the movement of the piston rod 5. In other words, if the spring 9 is designed as a compression spring, the piston rod 5 is moved against the spring force of the spring 9 in the direction of the housing 2 and with the support of the spring force in the direction away from the housing 2. However, the spring 9 can also be designed as a tension spring, so that the movement of the piston rod 5 is supported in the opposite direction.

FIG. 2 shows an embodiment of the actuating device with only one piston. With regard to the design of the actuating device 1, reference is made to FIG. 1 above. It is possible that the actuating device 1 comprises only one piston 10 that can move between two end positions and is operatively connected to the piston rod 5. At least one magnet system 12 is present in the housing wall 2, i.e. the magnet system 12 can be part of the housing in one embodiment. In the sense of the invention, the magnet system can thus be integrated in the housing wall, for example. Due to the magnet system 12, the piston 10, which can be moved between its end positions, can interact with at least the one magnet system 12 in at least one of its two end positions. In other words, the piston 10 is moved towards one of its end positions by adding actuating fluid to the fluid gaps 15 and is held there by at least one or no magnet system 12. However, the magnet system 12 can also support the movement of the at least one piston 10, i.e. it can additionally act as a force on the piston 10, so that the movement of the piston 10 is accelerated. In the end position of the at least one piston 10, the magnet system 12 can exert a magnetic holding force on the at least one piston 10. This means, in particular, that the magnetic system not only acts as a holding force, but in one embodiment can also act as an accelerating force.

It may be provided that a magnet system 12 is present in each of the two housing parts 3, 4 facing the moving piston 10, so that the moving piston 10 is held in both of its end positions by a magnet system 12. This means that the piston 10 is moved into one of its two end positions by an actuating fluid introduced into the fluid gaps 15 and is held there at least by a magnet system 12. With regard to the embodiment in which no magnet system 12 is present in the housing 2 or its components, e.g. the housing wall, reference is made to FIG. 1 above.

The piston 10 can advantageously consist of a ferromagnetic material, at least partially. The magnet systems 12 are preferably designed so that the pressure acting on the piston 10 due to the actuating fluid introduced can overcome the holding forces of the magnet system 12 and the piston 10 can move to the opposite end position. By using a coil in the magnet system 12 or as an exclusively electric magnet system 12, the magnet system 12 can be designed to be switchable. The piston 10 as a mobile structure can be fixed in both end positions without exciting the coil. If the movement of the piston 10 into the opposite end position triggered by the actuating fluid introduced into the fluid gaps 15 is to be supported, the coil can be energized so that the piston 10 is magnetically repelled and the movement of the piston 10 is supported. This makes it possible to switch the actuating device quickly and easily.

It should be noted that the figures illustrate the invention by way of example and that the technical functional principles and features of FIG. 2 are transferable to the embodiment shown in FIG. 1 and vice versa. Combinations of the features schematically illustrated by the figures are also covered by the teaching of the invention.

1. A magnetic actuating device (1) comprising a housing (2), a piston rod (5) that is movable between two end positions along a longitudinal axis of the housing (2) and has at least one piston (10) that extends radially from the piston rod (5) and is made of a ferromagnetic material or at least partially encompasses such a material, with at least one magnetic system (12) fixed to the housing, wherein the piston (10) and the magnetic system (12) form at least one fluid gap system (14) with axially variable fluid gaps (15), into which in each case at least one fluid supply (16) leads for the addition of actuating fluid, so that the piston rod (5) can be moved into its end positions at least by the addition of actuating fluid between the piston (10) and the magnet system (12).

2. The magnetic actuating device (1) according to claim 1, wherein the piston rod (5) has two pistons (10) which are arranged at a distance from one another, extend radially from the piston rod (5), and are made of a ferromagnetic material or at least comprise this material in some regions.

3. The magnetic actuating device (1) according to claim 2, wherein the magnet system (12) is arranged between the pistons in a manner fixed to the housing.

4. The magnetic actuating device (1) according to claim 1, wherein the actuating device comprises two magnet systems (12) fixed to the housing, between which the piston (10) can be moved and which each define an end position of the piston (10).

5. The magnetic actuating device (1) according to claim 1, wherein the magnet system (12) is designed to be rotationally symmetrical.

6. The magnetic actuating device (1) according to claim 1, wherein the magnet system (12) has an annular arrangement of one or more permanent magnets polarized in the same direction radially.

7. The magnetic actuating device (1) according to claim 1, wherein the magnet system (12) comprises a coil, which is associated with the magnet system (12) and can be connected to a power source.

8. The magnetic actuating device (1) according to claim 7, wherein the coil is of ring-shaped design and is flanked on both sides by permanent magnets.

9. The magnetic actuating device (1) according to claim 1, wherein the magnet system (12) has radially inner and/or radially outer pole pieces made from a magnetic-flux-conducting material.

10. The magnetic actuating device (1) according to claim 1, wherein the magnet system (12) is part of the housing (2).

11. The magnetic actuating device (1) according to claim 1, wherein the piston rod (5) forms a receptacle for an actuator (8) passing through the piston rod (5) along the longitudinal axis.

12. The magnetic actuating device (1) according to claim 1, wherein a spring (9) acts directly or indirectly on the piston rod (5).

13. The magnetic actuating device (1) according to claim 1, wherein at least one guide means (11) is provided for axially guiding at least one piston (10) along the longitudinal axis.

14. The magnetic actuating device (1) according to claim 1, wherein the housing (2) is of a multi-part design.

15. The magnetic actuating device (1) according to claim 1, wherein the piston rod (5) comprises a rotary feedthrough (18) for the passage of one or more fluid channels.

16. The magnetic actuating device (1) according to claim 1, wherein the fluid supply (16) is also designed as a fluid outlet.

17. The magnetic actuating device (1) according to claim 1, wherein in addition to the fluid supply (16), there is in each case at least one fluid outlet in the fluid gaps (15).
